(19) United States
(12) Patent Application Publication
(10) Pub. No.: US 2020/0217306 A1
(43) Pub. Date: Jul. 9, 2020

(54) SYSTEMS AND METHODS FOR GENERATING, STORING AND TRANSMITTING ELECTRICITY FROM VEHICULAR TRAFFIC

(71) Applicant: Uncharted Power, Inc., New York, NY (US)

(72) Inventors: Jessica Osemudiamen Idoni Matthews, New York, NY (US); Daniel Bish, Brooklyn, NY (US); Xin Du, New York, NY (US); Jared Glassman, New York, NY (US); Raya Islam, Slidell, LA (US); Deanna Kovalcin, New York, NY (US); Parth Ranjan Singh, New York, NY (US); Lauren Tweel, Demarest, NJ (US)

(21) Appl. No.: 16/643,714

(22) PCT Filed: Aug. 31, 2018
(86) PCT No.: PCT/US2018/049258

§ 371 Date: Mar. 2, 2020

Related U.S. Application Data
(60) Provisional application No. 62/552,940, filed on Aug. 31, 2017.

(51) Int. Cl. F03G 7/08; E01F 9/571; E01F 9/529; H02N 2/18

(52) U.S. Cl. CPC F03G 7/08; H02N 2/183; E01F 9/529; E01F 9/571

(57) ABSTRACT

An energy harvesting system can comprise an actuator comprising a translationally displaceable surface, the translationally displaceable surface being configured to transition from a first position to a second position upon contact by a movable unit; a vertical rack in contact with the actuator, and configured to be translationally displaced in response to translational displacement of the actuator; a pinion configured to engage with the vertical rack and to rotate in response to translational displacement of the vertical rack; a main shaft coupled to the pinion and configured to rotate with rotation of the pinion; and a flywheel and a generator coupled to the main shaft, wherein rotation of the main shaft generates mechanical energy stored by the flywheel, and wherein the generator is configured to generate electrical energy from the mechanical energy stored by the flywheel.

### CROSS-REFERENCE

This application claims the benefit of U.S. Provisional Application No. 62/552,940, filed Aug. 31, 2017, which application is entirely incorporated herein by reference.

### BACKGROUND

Movement of motorized vehicles, non-motorized vehicles, humans, and/or animals across surfaces can result in forces exerted upon the surfaces. However, such forces are rarely converted into another form that may be useful for other applications. The forces exerted upon the surfaces may be absorbed and/or dissipated by these surfaces.

### SUMMARY

Recognized herein is the need to capture kinetic energy from various motions that would otherwise be wasted. Force exerted upon surfaces by a movable unit, such as a human, an animal, a vehicle (e.g., motorized and/or non-motorized vehicles), and/or other object, when the movable unit is traversing across the surface, can be converted to mechanical energy. The devices and components described herein may capture mechanical energy, via a linear to rotational mechanism, and convert such captured mechanical energy to electrical energy used to power any number of electrical devices or equipment requiring electricity and/or power. For example, the energy captured may initially be accumulated in a mechanical storage device until a meaningful amount of energy is stored. The mechanical energy may then be converted to electrical energy through, for example, the engagement of an induction generator. Electrical power can then be delivered to various electronic application units, such as light sources (e.g., lamps) and other electronic devices. Described herein are systems, methods and apparatuses related to harvesting electrical energy from kinetic energy generated by perturbations due to contact between a surface and a movable unit. An energy harvesting system can be integrated into and/or be a surface with which the movable unit comes into contact when the movable unit is in motion, such as a road surface. An energy harvesting system can be used to generate energy from the contact of the system with the movable unit. The contact between the movable unit and the one or more surfaces can result in physical displacement of the surfaces, for example generating kinetic energy resulting from the translation of the one or more surfaces from a first position to a second position (e.g., from a first vertical position to a second lower vertical position). The translational movement of the one or more surfaces can be converted to rotational movement by the energy harvesting system. Mechanical energy in the rotational movement can subsequently be converted to electrical energy using an electrical generator such that electricity can be produced to power an external circuit or be stored in electrical energy storage systems (e.g., batteries) for future use. The entire device can be contained in a modular housing that can be connected to, for example, another such device in a modular housing. When connected, these components can function as, for example, energy harvesting speed bumps, walkways, roadways, sidewalks, and similar surfaces and locations which experience significant traffic. These components can be collectively referred to herein as “energy harvesting roadway,” “energy harvesting speed bump,” or “energy harvesting speed system.” The components can be combined to form an energy harvesting roadway.

The disclosed energy harvesting roadway and components may benefit various industries. For example, when used as a regular roadway, a user may drive over the roadway as one normally does, but the disclosed energy harvesting roadway may harvest the energy transferred from the user's vehicle to the road. Alternatively or additionally, the disclosed energy harvesting roadway may also harvest energy from any object of sufficient weight (e.g., luggage, cars, carts, trucks, animals, humans, wheelbarrows, etc.) by depressing the surface of the invention. The harvested energy may be used to power streetlights or other electronics. Alternatively or additionally, the harvested energy may be used to power or partially power nearby homes, schools, hospitals, governmental buildings, community centers, covered areas such as gazebos, or other buildings requiring power. Alternatively or additionally, the harvested energy may be used to power electrical components within the system itself such as microcontrollers, converters, sensors, energy monitoring systems, or microprocessors including accessories like data storage and network equipment.

Furthermore, the modularity and scalability of the energy harvesting roadway design may enable the energy harvesting encasements, in combination, to harness energy on a larger scale.

In an aspect, provided is a modular energy harvesting system, comprising: a first modular housing comprising: an actuator comprising a translationally displaceable surface, the translationally displaceable surface being configured to transition from a first position to a second position upon contact by a movable unit; a linear to rotational conversion component for converting linear motion input from the actuator into a rotational motion output, wherein the linear to rotational conversion component is mechanically coupled to the actuator to receive the linear motion input from the transition of the translationally displaceable surface from the first position to the second position; a mechanical energy storage component mechanically coupled to the linear to rotational conversion component to store at least part of the mechanical energy derived from the rotational motion output; a generator coupled to the mechanical energy storage component, wherein the generator is configured to generate electrical energy from the mechanical energy stored by the mechanical energy storage component; a first modular connector disposed on a first surface of the first modular housing and a second modular connector disposed on a second surface of the first modular housing.

In some embodiments, the system further comprises a second modular housing comprising a third modular connector engaging the first modular connector. In some embodiments, the system further comprises a third modular housing comprising a fifth modular connector engaging the second modular connector.

In some embodiments, the system further comprises, a gearbox coupled to the linear to rotational conversion component and the mechanical energy storage component.

In some embodiments, the linear to rotational conversion component comprises a rack and pinion mechanism.

In some embodiments, the linear to rotational conversion component comprises a screw transmission.

In some embodiments, the mechanical energy storage component is a flywheel.

In some embodiments, the first modular housing is disposed beneath a contact surface traversed by the movable unit. In some embodiments, the contact surface is one or more of a speedbump and roadway.

In some embodiments, the translationally displaceable surface of the actuator protrudes from an external surface of the first modular housing.

In some embodiments, the system further comprises a release mechanism mechanically coupled to the mechanical energy storage component, wherein the mechanical energy is released from the mechanical energy storage component to the generator upon activation of the release mechanism. In some embodiments, the release mechanism comprises one or more of a latch and valve configured to activate when the stored mechanical energy reaches a predetermined threshold.

In some embodiments, the system further comprises an electrical energy storage component electrically coupled to the generator.

In some embodiments, the generator is a two-part generator comprising a stator and a rotor, wherein either a stator or rotor is configured to rotate relative to the other upon release of the mechanical energy storage component.

In some embodiments, the generator is an induction generator configured to rotate upon release of the mechanical energy of the mechanical energy storage component.

In another aspect, provided is an energy harvesting system, comprising: an actuator comprising a translationally displaceable surface, the translationally displaceable surface being configured to transition from a first position to a second position upon contact by a movable unit; a vertical rack in contact with the actuator, and configured to be translationally displaced in response to translational displacement of the actuator; a pinion configured to engage with the vertical rack and to rotate in response to translational displacement of the vertical rack; a main shaft coupled to the pinion and configured to rotate with rotation of the pinion; and a flywheel and a generator coupled to the main shaft, wherein rotation of the main shaft generates mechanical energy stored by the flywheel, and wherein the generator is configured to generate electrical energy from the mechanical energy stored by the flywheel.

In some embodiments, the system further comprises a gearbox coupled to the main shaft.

In some embodiments, the system further comprises a frame housing the actuator, the vertical rack, the pinion, the main shaft, and the flywheel.

In some embodiments, the frame is disposed beneath a contact surface traversed by the movable unit. In some embodiments, the contact surface is one or more of a speedbump and roadway.

In another aspect, provided is a method for harvesting energy, comprising: providing at each of a plurality of locations on a surface, including a first location and a second location, a modular housing, comprising: (i) an actuator configured to transition from a first position to a second position upon contact by a movable unit exerting a force on the surface; (ii) a linear to rotational conversion component for converting linear motion input from the actuator into a rotational motion output, wherein the linear to rotational conversion component is mechanically coupled to the actuator; (iii) a mechanical energy storage component mechanically coupled to the linear to rotational conversion component; (iv) a generator coupled to the mechanical energy storage component; and (v) electric circuitry electrically coupled to the generator; at the first location and the second location, receiving a linear motion input from the movable unit exerting the force on the surface; converting each linear motion input into respective rotational motion outputs via the respective linear to rotational conversion components in the first and second locations; storing each of the respective rotational motion outputs as mechanical energy in the respective mechanical energy storage components in the first and second locations; releasing the mechanical energy to the respective generators in the first and second locations, thereby generating respective power outputs at the first and second locations on the surface; and amalgamating the respective power outputs from the first and second locations, via the respective electric circuitry at the first and second locations, to produce an amalgamated power output and delivering the power output for storage in a power storage component or for powering one or more electronic devices.

In another aspect, provided is a modular energy harvesting encasement system, comprising: an actuator configured to contact a movable unit; a linear to rotational conversion component for converting a linear motion input into a rotational motion output; a mechanical energy storage component for storing the rotational motion output as mechanical energy, wherein the mechanical energy storage component is mechanically coupled to the linear to rotational conversion component (e.g., via a plurality of gears); a generator, wherein at least a part of the generator is configured to generate power output upon release of the mechanical energy of the mechanical energy storage component; electric circuitry electrically coupled to the generator for storing, or powering an electronic device with, the power output; and an encasement for enclosing the linear to rotational conversion component, the mechanical energy storage component, the generator, and the electric circuitry.

In some embodiments, the linear to rotational conversion component comprises a screw transmission.

In some embodiments, the linear to rotational conversion component comprises a rack and pinion mechanism.

In some embodiments, the plurality of gears comprises a planetary gear system.

In some embodiments, the generator is an induction generator configured to rotate upon release of the mechanical energy of the mechanical energy storage component.

In some embodiments, the generator is a two-part generator comprising a stator and a rotor, wherein either a stator or rotor is configured to rotate relative to the other upon release of the mechanical energy.

In some embodiments, the actuator protrudes from a surface of the energy harvesting system.

In some embodiments, there are multiple actuators disposed on the surface such that the movable unit is able to make contact with at least one while traversing the surface. An increased number of actuators may result in an increase in energy generated from the system.

In another aspect, provided is a method for generating and amalgamating electrical energy, comprising: at each of a plurality of locations on a surface, including a first location and a second location, receiving a linear motion input; converting each linear motion input into respective rotational motion outputs via a linear to rotational conversion component located at each of the plurality of locations; storing each of the respective rotational motion outputs as mechanical energy in a mechanical energy storage component located at each of the plurality of locations mechanically coupled to the linear to rotational conversion component; releasing the mechanical energy to rotate at least part of a generator located at each of the plurality of locations, wherein the generator is mechanically coupled to the mechanical energy storage component, thereby generating power output at each of the plurality of locations on the surface; and amalgamating the respective power outputs from each of the plurality of locations, including the first location and the second location, via electric circuitry, to produce an amalgamated power output and delivering the power output, via electric circuitry, for storage in a power storage component or for powering one or more electronic devices.

In some embodiments, the linear to rotational conversion component comprises a screw transmission.

In some embodiments, the linear to rotational conversion component comprises a rack and pinion mechanism.

In some embodiments, the mechanical energy storage component comprises a flywheel mechanically coupled to the generator. In some embodiments, the method can further comprise rotating the flywheel after the linear motion input has stopped.

In some embodiments, the plurality of gears comprises a planetary gear system.

In some embodiments, the generator is an induction generator configured to rotate upon release of the mechanical energy of the mechanical energy storage component.

In some embodiments, the generator is a two-part generator comprising a stator and a rotor, wherein either a stator or rotor is configured to rotate relative to the other upon release of the mechanical energy.

In some embodiments, the actuator protrudes from the surface of the energy harvesting system.

In some embodiments, there are multiple actuators disposed on the surface such that the movable unit is able to make contact with at least one while traversing the surface. An increased number of actuators may result in an increase in energy generated from the system.

In some embodiments, the linear motion input originates from traffic on the surface.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious aspects, all without departing from the disclosure accordingly, the drawings and descriptions are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings (also “figure” and “FIG.” herein) of which:

FIG. 1 illustrates a side view of a speed bump according to some embodiments.

FIG. 2 illustrates a top-down perspective view of the speed bump of FIG. 1.

FIG. 3 illustrates a top-down view of the speed bump of FIG. 1.

FIG. 4 illustrates a close-up view of a portion of the speed bump of FIG. 1.

FIG. 5 illustrates a close-up view of another portion of the speed bump of FIG. 1.

FIG. 6 shows an exemplary circuit for a boost converter (e.g., DC-to-DC power converter), in accordance with embodiments of the invention.

FIG. 7 shows an exemplary amalgamation circuit, in accordance with embodiments of the invention.

FIG. 8 illustrates a top-down view of a roadway according to some embodiments.

FIG. 9 illustrates a top-down perspective view of the roadway of FIG. 8.

FIG. 10 illustrates a top-down perspective view of the roadway of FIG. 8, with internal components made visible.

FIG. 11 illustrates a cross-sectional side view of the roadway of FIG. 8, with internal components visible.

FIG. 12 illustrates a close-up cross-sectional side view of a portion of the roadway of FIG. 8.

FIG. 13 illustrates a close-up view of the portion of roadway of FIG. 12.

FIG. 14 illustrates an exploded view of the portion of the roadway of FIG. 12.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Provided herein are systems and methods for harvesting energy (or generating power) through contact surfaces, such as speed bumps and roadways. Such systems and methods may utilize physical perturbations due to contact between a surface and a movable unit interfacing the surface. An energy harvesting system as described herein can be used to generate electrical energy from the contact of the system with the movable unit. Such systems may harvest energy generated due to a force exerted by the movable unit upon a surface while the movable unit is traveling on, over, or across, the surface. An energy harvesting system may comprise a plurality of distinct energy harvesting units. The energy harvesting units can be incorporated as a part of, or form, one or more surfaces which contacts the movable unit while the movable unit is in motion.

Contact between the movable unit and the one or more surfaces can result in physical displacement of the surfaces. In some instances, contact between the movable unit and the one or more surfaces can also result in partial physical displacement of the surfaces, wherein part of the surface will displace while in contact with the movable unit while a portion of the surface remains stationary. The contact can result in translational, or substantially translational, movement of the one or more surfaces from a first position to a second position (e.g., from a first vertical position to a second lower vertical position). The energy harvesting system can be configured to harvest at least a portion of the kinetic energy resulting in the displacement of the surfaces. For example, a vehicle in motion can contact a surface of one or more energy harvesting systems as described herein to cause a translational displacement (e.g., a linear or substantially linear displacement) of the one or more surfaces. The translational movement of the one or more surfaces can be converted to rotational movement by the system. The rotational movement can be stored as mechanical energy within the system, such as in a mechanical storage device of the energy harvesting system. Alternatively or additionally, the translational movement of the one or more surfaces can be first stored as mechanical energy within the system, such as in a mechanical storage device of the energy harvesting system, and then further converted to rotational movement by the system.

In some cases, mechanical energy can be accumulated in the mechanical storage device, such as a flywheel or torsion spring, until a desired (e.g., above a predetermined threshold) amount of energy is stored. The energy harvesting system can comprise a generator, such as an induction generator, to convert the mechanical energy to electrical energy. When this conversion is set to take place, the energy stored in the mechanical storage device can be released by a release mechanism, such as but not limited to a latch or electrically controlled valve. In some cases, the energy harvesting system can comprise an electrical energy storage component to store generated electricity (e.g., a battery). Electrical energy stored in the electrical energy storage component can be delivered to power an external load. Generated electricity can be delivered to power, for example, various electronic devices, light sources, security systems, WIFI hotspots, data acquisition devices, nearby homes, schools, hospitals, governmental buildings, community centers, other buildings requiring power microcontrollers, converters, sensors, energy monitoring systems, microprocessors including accessories like data storage, network equipment, and any other electrical load. In some cases, generated electrical energy can be delivered directly to an external load without (or substantially without) separately storing the electrical energy in the energy harvesting system. The final power outputted from the system can be accessed for example via a battery, other electrical storage device, an electronic device directly powered by the system, wired connection to the system, and/or via wireless energy transmission (e.g., on demand wireless energy transmission). The system may also include a smart wired or wireless transmission system that is able to either manually or automatically transmit power to the devices that need it the most based on their intended use case priority.

As described herein, one or more energy harvesting systems described herein can be incorporated within and/or form a part of a surface. The surface can be any type of surface intended for travel, including a road surface, a pavement, or any other surface intended for travel. In some cases, the surface can be a horizontal surface, a vertical wall, an inclined hill, and/or a slide that a movable unit traverses over, and/or across. In another example, the surface can be a railway, railroad or rail track. In another example, the surface can be a ramp. In some cases, the surface can be a specialized or customized traveling surface.

In some cases, the entire energy harvesting system can be housed in an encasement. For example, the encasement can contain within its walls the surface that the movable unit traverses over, the actuator, the linear to rotational mechanism, the mechanical energy storage device, the electrical energy storage device, release mechanism, and/or all other necessary and associated components for delivering harnessed electrical energy to one or more loads. The encasement can be as small or as large as is necessary to house all the required components. In some cases, the encasement can be disposed in a trench dug in the ground such that when inserted the encasement lies relatively or completely flush to the existing ground. Alternatively, or additionally, the encasement can be laid directly atop the existing road or ground and appropriately secured to such. In some cases, only a portion of the energy harvesting system can be housed in an encasement. For example, one or more parts (e.g., the electrical energy storage device, cables, etc.) of the energy harvesting may be external to the encasement and operatively coupled to other parts disposed in the encasement.

The encasement can either operate as an individual standalone system, or can be connected to other encasements. In some cases, multiple encasements can comprise individual energy harvesting systems therein which may be identical to one another. In some cases, multiple encasements can comprise individual energy harvesting systems therein which are not identical to one another, for example comprising at least two systems which are not identical to one another. In some instances, a single encasement, or module, can be used for smaller scale applications to harvest energy. Multiple encasements (or modules) can be connected together to form larger systems, such as a roadway, highway, or thruway. An increased number of energy harvesting systems can facilitate an increased harvesting of energy, and can be used for larger scale applications. The energy harvesting system may comprise a method for amalgamating modular power outputs generated by a plurality of individual energy harvesting mechanisms.

The force exerted by the movable unit upon the relevant surface (e.g., part of the energy harvesting system) can be a weight of the movable unit and/or other forces (e.g., created by engines, manual labor, etc.) directed towards the surface. For example, when the movable unit is a motorized vehicle, the motorized vehicle can be propelled by one or more power generation (or conversion) devices, including electric engines, electrochemical engines, combustion engines (e.g., internal combustion engines, turbines), or any other power generation devices, or combinations thereof. The one or more power generation devices may be coupled to a motor (e.g., a battery may be coupled to an electric motor), a drivetrain, or any combination thereof. In another example, a movable unit (e.g., stroller cart) may be manually pushed towards the surface during travel. Any movable unit may exert a weight towards the surface.

The movable unit may be an automobile exerting force (e.g., weight, etc.) as it rests on and/or travels (e.g., wheels roll) across the surface. Alternatively, the movable unit may be a vehicle, a car, a truck, a bus, a tank, a motorcycle, a bicycle, a trailer, a board, a scooter, a railcar, a train, an airplane, or any other type of automobile. An automobile may interface with the surface via rotating (e.g., wheels, tracks, etc.), sliding, pedaling, or via any other interface configured to move an automobile relative to the surface. Alternatively, or in addition, the movable unit may be a stroller or a cart, or any other movable unit that an automobile or a person can push, pull, or otherwise carry across the surface. Alternatively, or in addition, the force may be exerted by a person or a plurality of persons, animals or a plurality of animals, walking, running, or otherwise interfacing with the surface. Alternatively, or in addition, the movable unit can be any object capable of moving that interfaces the surface.

The movable unit may move across and/or over one or more surfaces of an energy harvesting system at a relatively low speed (e.g., less than 15 miles per hour). Alternatively, the movable unit may be travelling at any other speed. The movable unit may have a mass on the order of at least about 0.1 pounds, 1 pound, 10 pounds, 100 pounds, 1000 pounds, 10,000 pounds or more, and exert a weight (e.g., via gravitational force) on the one or more surfaces. Alternatively, the movable unit may comprise a greater or lesser mass with corresponding weight.

One or more energy harvesting systems as described herein can comprise a customizable, modular, and/or scalable system. An energy harvesting system can be configured to capture kinetic energy created by translational perturbations (e.g., linear or substantially linear perturbations) from vehicles that would otherwise be wasted energy. In some cases, the energy harvesting system can be incorporated into and/or form a speed deterring device for regulating speed, such as a speed bump. For example, components of the energy harvesting system can be integrated into an apparatus that can serve as a speed bump for vehicles.

In some cases, one speed bump can comprise multiple energy harvesting mechanism setups incorporated therein, thus enabling the passing of one vehicle to actuate multiple linear to rotational mechanisms. For example, this actuation can turn multiple generators at once and/or comprise mechanically combining the motion to turn one electrical generator at a higher speed.

In some cases, multiple speed bumps can be used for harvesting energy, including 2, 3, 4, 5, 6, 7, 8, 9, 10 or more individual speed bumps. Each individual speed bump can comprise one or more energy harvesting energy systems therein, or one or more energy harvesting systems can form each individual speed bump. For example, a speed bump can either operate as an individual standalone system, or can be connected to other speed bumps. In some cases, multiple speed bumps can comprise individual energy harvesting systems therein which are identical to one another. In some cases, multiple speed bumps can comprise individual energy harvesting systems therein which are not identical to one another, for example comprising at least two which are not identical to one another. One speed bump can be used for smaller scale applications. Multiple speed bumps can be used together to form larger systems, such as speed humps, speed tables, speed cushions and/or roadways. An increased number of speed bumps can facilitate increased harvesting of energy. Examples of multiple speed bumps can include: 10-12 speed bump modules connected to create a speed hump; 20-22 speed bump modules connected to create a speed table.

In some cases, the energy harvesting system can be incorporated into and/or form a roadway to be traversed by movable units at any speed. For example, components of the energy harvesting system can be integrated into an apparatus that can serve as a roadway, highway, or thruway, without deterring or interfering with the speed of the movable unit. In some instances, the surface may contain a portion that protrudes above the surrounding surface. The protrusion can have a height of at least about 0.5 inches, 1 inch, 1.5 inches, 2 inches, 4 inches, or more. Alternatively, the protrusion may have a height less than 0.5 inches.

In some cases, one road can comprise multiple energy harvesting mechanisms (e.g., modules) incorporated therein, thus enabling the passing of one vehicle to actuate multiple linear to rotational mechanisms. Alternatively, or additionally, multiple actuations of linear to rotational mechanisms can be mechanically combined to turn one electrical generator, resulting in a higher speed, a higher resistance, or some combination of both, of the rotation of the electrical generator (relative to the rotation of an electrical generator from the actuation of a single linear to rotational mechanism).

One or more energy harvesting systems described herein can be used to satisfy the extremely high demand for power, particularly in developing areas of the world, such as the continents of Africa and South America.

The energy harvesting system may be integrated into or form surfaces of the grounds or roads of parking lots, gas stations, stop sign intersections, toll booths, speedbumps, private driveways, sharp curves, and/or other key locations where traffic speed is low and traffic is regular to yield significant power outputs. The energy harvesting system may also be integrated into or form surfaces of the grounds or roads of primary roads, local roads, highways, thruways, freeways, ramps, and/or other key locations where traffic speed is high and traffic is regular to yield significant power outputs. The energy harvesting system may be integrated into or form surfaces of other specialized paths or specialized travel structures, such as drive thru paths, single lane paths, railways, rail tracks, or other paths defining a specific travel path. The energy harvesting system may be advantageously placed in locations that accurately expect travel and/or can be optimized to harvest energy from specific types of vehicles (e.g., rail cars) having predictable weight and/or travel speed.

In some cases, electrical energy generated by individual systems can be combined, such as using an electrical energy amalgamation system, prior to delivery of the electrical energy to an external circuit. In some cases, mechanical energy harvested by individual systems can be combined, such as using a mechanical energy amalgamation system, prior to conversion of the mechanical energy to electrical energy.

In one example, as a vehicle, such as a motorized vehicle (e.g., a passenger car, truck, bus, trolley and/or motorcycle), drives over a speed bump comprising one or more energy harvesting systems as described herein, contact between the vehicle and the energy harvesting system can result in contact of one or more surfaces of the energy harvesting systems to cause a linear displacement of the surfaces. The linear movement can be converted to rotational movement such that the rotational movement can be used to generate electricity within the energy harvesting system. The electrical energy can then be delivered to a circuit external to the energy harvesting system to power the external circuit. In some cases, individual energy harvesting systems can comprise a modular configuration such that multiple systems can be combined together. For example, multiple modules can be used together as a speed bump, hump, table, and/or roadway. In some cases, multiple speed bumps or portions of a road, each comprising one or more energy harvesting systems, can be connected to create a scalable system, for example to form a speed hump, speed table, speed cushion, and/or roadway. The energy harnessed from each module can be accumulated either mechanically and/or electrically. In some cases, the modules can be connected in series and/or in parallel. The harnessed energy can be used to power any number of electrical devices, including for example streetlights, security systems, WIFI hotspots, nearby homes, schools, hospitals, governmental buildings, community centers, other buildings requiring power, microcontrollers, converters, sensors, energy monitoring systems, or microprocessors including accessories like data storage and network equipment. In some cases, energy generated by one or more systems described herein can be used in combination with other traffic safety equipment to further improve traffic safety. For example, the energy can be used to power street lighting, road cameras, security systems, traffic light, under vehicle scanning systems, and/or other electrical units of the infrastructure.

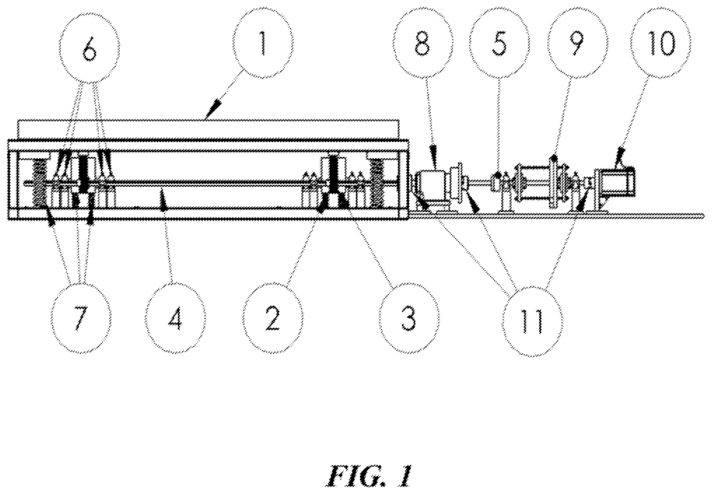

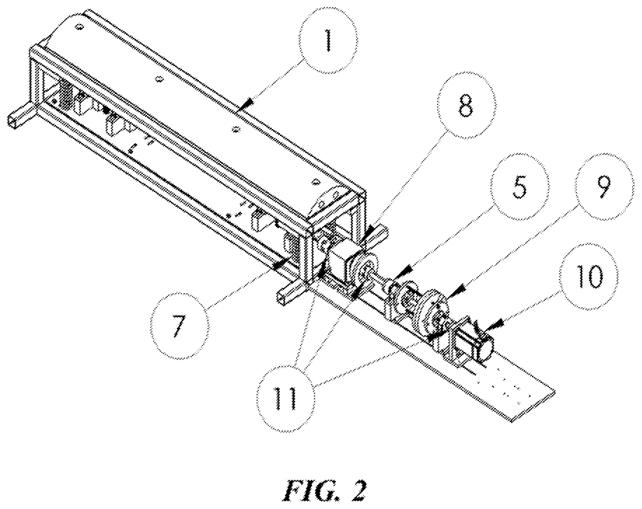

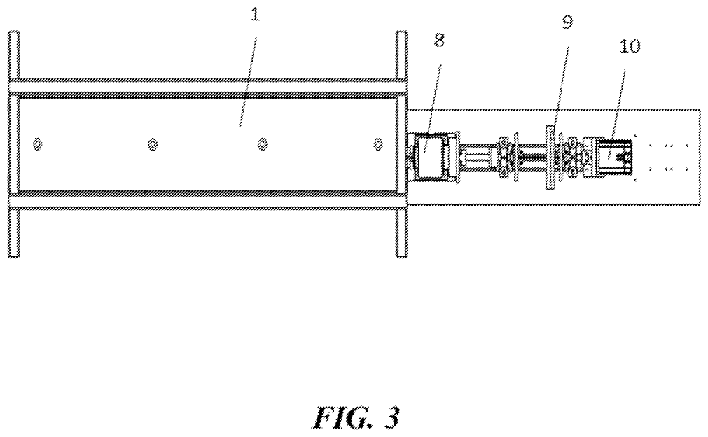

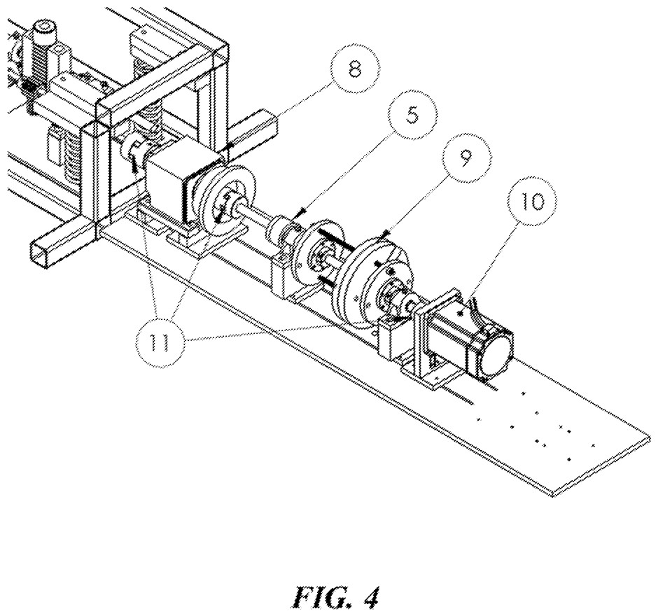

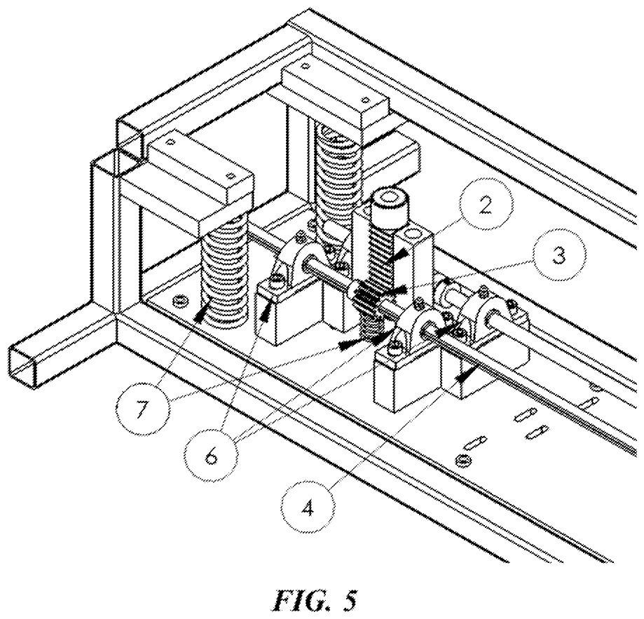

An example of an energy harvesting system 100 is described with reference to FIGS. 1-5. FIG. 1 is a schematic side view of the energy harvesting system 100. FIG. 2 is a schematic top-down perspective view of the energy harvesting system 100, while FIG. 3 is a schematic top-down view of the system. FIG. 4 shows a closer view of a portion of the energy harvesting system, and FIG. 5 shows a closer view of another portion of the energy harvesting system. It will be understood that similarly numbered reference numerals in the figures refer to the same features throughout the disclosure.

In some embodiments, the linear to rotational mechanism can be optimized to harness energy from a limited depression of the energy harvesting roadway or speedbump device. Beneficially, the user or movable unit may feel minimal depression as the user or movable unit travels across the surface. Such depression amount can be set up to optimize the amount of force translated to the system, while also limiting the negative reaction (or any reaction) the user may experience from the actuator depressing. For example, the energy harvesting device may deviate (e.g., depress) by at most about 5 inches, 4 inches, 3 inches, 2 inches, 1 inch, 0.5 inches, or less between the resting state and the active state (upon exertion of a force). Alternatively, the energy harvesting system may not be limited as to the extent of deviation. While the term “depression” is used, it will be appreciated that any movement referred to as a “depression” can be in any direction (and not just downwards). In some instances, the direction of depression can be aligned or substantially aligned in the direction that force is exerted (and/or received). In some instances, the direction of depression can be aligned to be normal or substantially normal to the surface. For example, where the energy harvesting system is installed beneath a level road, the actuator can be configured to press down (e.g., normal to the ground). Where the energy harvesting device is installed behind a wall (e.g., normal to the ground), the actuator can be configured to press sideways (e.g., normal to the wall surfaces). Alternatively, or in addition, the direction of the actuator can be at a different angle (not 90) to the surface.

In some embodiments, the linear to rotational mechanism may capture forces coming from a plurality of directions, for example, a vertical direction, a horizontal direction, a normal direction (e.g., normal to the surface of the energy harvesting system), or any other angled forces. Such forces may be converted into rotational motion via the linear to rotational mechanism.

The energy harvesting system 100 serves as one example of such a system. One skilled in the art would understand that various components and/or parameters of an energy harvesting system are not so limited. An energy harvesting system can have various configurations, such as various heights, widths, lengths, and/or heights of depression, to facilitate desired energy generation while serving as a speed deterrent (e.g., to be incorporated as a part of, or serve as, a speed hump, speed table, and/or speed cushion or roadway) or while serving as a regular speed road (e.g., to be incorporated as a part of, or serve as, a roadway, highway, and/or thruway)

As shown in FIGS. 1-5, the energy harvesting system 100 can comprise an actuator 1, vertical racks 2, pinions 3, main shaft 4, a one way bearing 5, bearings 6, springs 7, a gearbox 8, flywheel 9, a generator 10, and shaft couplers 11.

The actuator 1 can comprise at least a portion configured to come into contact with a movable unit and transform the contact into displacement of the portion of the actuator. In some cases, the portion of the actuator configured to contact the movable unit can form a portion of an upper external surface of the energy harvesting system. The portion of the actuator which contacts the movable unit can be configured to be linearly displaced as a result of the contact. For example, the portion of the actuator which contacts the movable unit can be vertically displaced downward upon contact with the movable unit. The actuator can be spring-loaded. For example, the actuator can be coupled to springs 7 configured to revert the actuator back to its initial position once pressure from the movable unit is removed. The springs 7 can maintain the actuator in an undepressed state when no pressure is exerted upon the actuator by the movable unit.

As described herein, in some cases, the energy harvesting system can be integrated into a speed bump in a roadway. The portion of the actuator configured to contact the movable unit can be shaped and dimensioned to achieve desired speed reduction while avoiding excessive disturbance to the movable unit while moving over the speed bump. In some cases, the actuator may comprise a curved portion configured to contact the movable unit. The curved portion can be dimensioned to facilitate integration into a speed bump. For example, the curved portion of the actuator can comprise a semicircular shape. In some cases, the curved portion of the actuator can comprise a semi-elliptical and/or a parabolic shape. In some cases, the portion of the actuator which contacts the movable unit comprises a shape other than a curved shape, such as a polygonal shape.

Alternatively, or additionally, the portion of the actuator configured to contact the movable unit can comprise a protrusion, such as a “flapper”. The protrusion can be configured to be positioned at an angle relative to the ground and to rotate around an axis upon contact by the movable unit such that the protrusion then is positioned parallel or substantially parallel to the ground (e.g., flush with the ground). For example, the protrusion can be configured to be rotatable around a hinge such that the protrusion can be rotated upon contact with the movable unit to a position where the protrusion lays flush with the ground when a vehicle is applying pressure upon it.

In some cases, the actuator 1 can be configured to increase the amount of force inputted into the system, for example enabling an increase in the amount of energy outputted from the system. The actuator can be shaped and/or dimensioned (e.g., height, width, length, and/or height of depression) to facilitate desired speed deterrence or speed regulation and energy generation while avoiding excessive disturbance and/or unreasonable discomfort for a passenger of a vehicle as the vehicle moves over the speed bump or roadway.

The vertical racks 2 can be configured to contact the actuator 1, such as when the actuator is displaced during contact with the movable unit. Movement of the actuator can be transferred to the vertical racks such that the vertical racks are displaced as a result of the displacement of the actuator. The vertical racks can be in contact with a lower surface of the actuator, for example as shown in FIG. 1. The vertical racks are shown in further details in FIG. 5. The vertical racks can be in contact with the actuator such that displacement, for example depression, of the actuator can initiate a downward movement of the vertical racks in contact with the underside of the actuator. An energy harvesting system can comprise one or more vertical racks. In some cases, the system can comprise two vertical racks. In some cases, the system comprises more than two vertical racks, including 3, 4, 5, 6, 7, 8, 9, 10 or more vertical racks. As described herein, the actuator can be coupled to the springs 7 such that the actuator is maintained in an undepressed state when no pressure is exerted upon the actuator, thereby enabling the vertical racks to resume an undepressed state. For example, after the movable unit has moved over and past the energy harvesting system, the springs 7 can push the actuator, and attached vertical racks, back to their initial undepressed position.

The energy harvesting system 100 can comprise pinions 3 configured to be in contact with the vertical racks 2, for example as shown in FIG. 1 and in further details in FIG. 5. The pinion can be configured to engage with the vertical racks such that displacement of the vertical racks results in rotational movement of the pinion. The vertical racks can comprise a plurality of protrusions on a surface in contact with the pinion such that the protrusions of the vertical racks engage with corresponding recesses on the pinion. The coupling of the vertical racks and the pinion can transform linear displacement of the vertical racks into rotational movement of the pinion. The mating engagement between the pinion and the vertical racks can transform vertical displacement into rotational movement.

The pinion 3 can be coupled to the main shaft 4. Rotation of the pinion 3 can result in rotation of the main shaft 4. The one way bearing 5 can be coupled to the main shaft such that rotation of the main shaft can result in rotation of the one-way bearing. The position of the main shaft relative to other components of the energy harvesting system 100 can be maintained by the plurality of bearings 6. Location of the plurality of bearings can be selected based on the desired positioning of the main shaft. Referring to FIGS. 1 and 5, for example, the bearings can be positioned proximate to the vertical racks 2 and pinion 3.

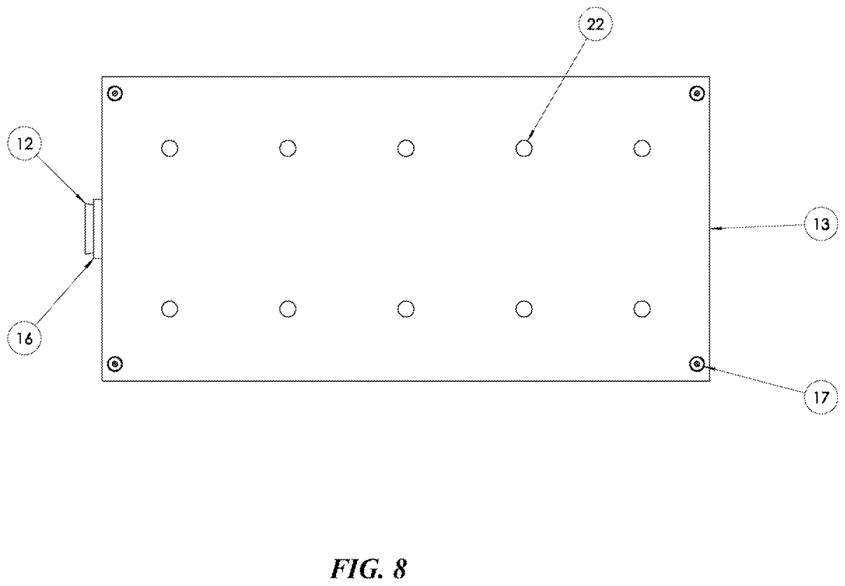

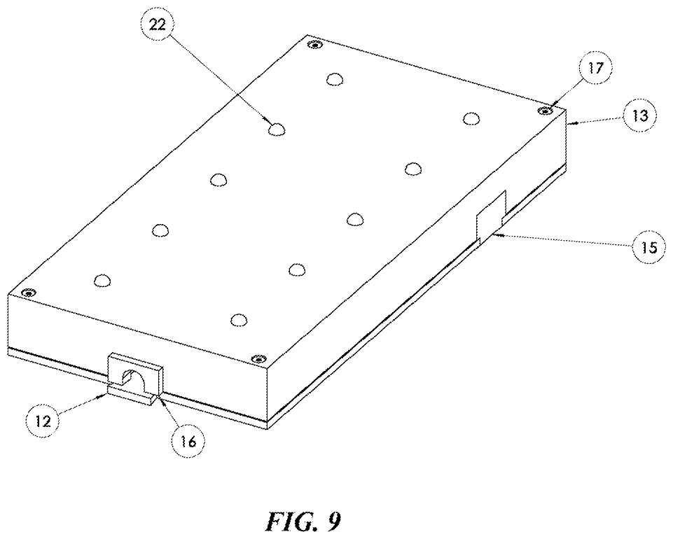

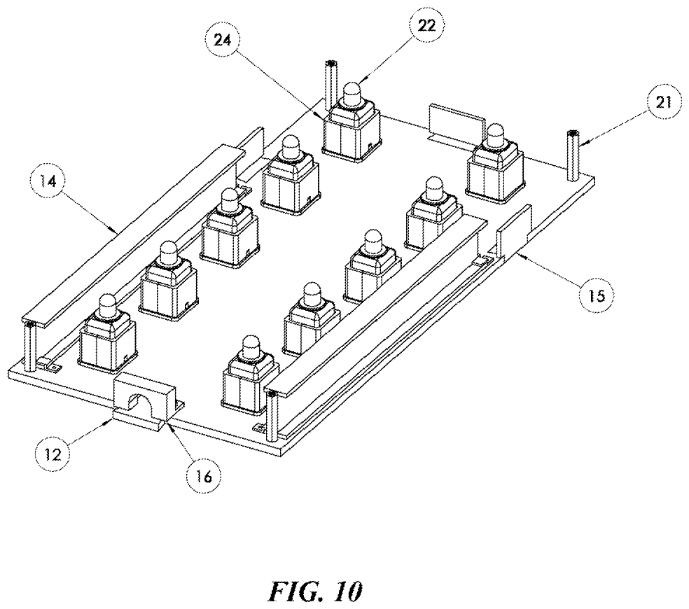

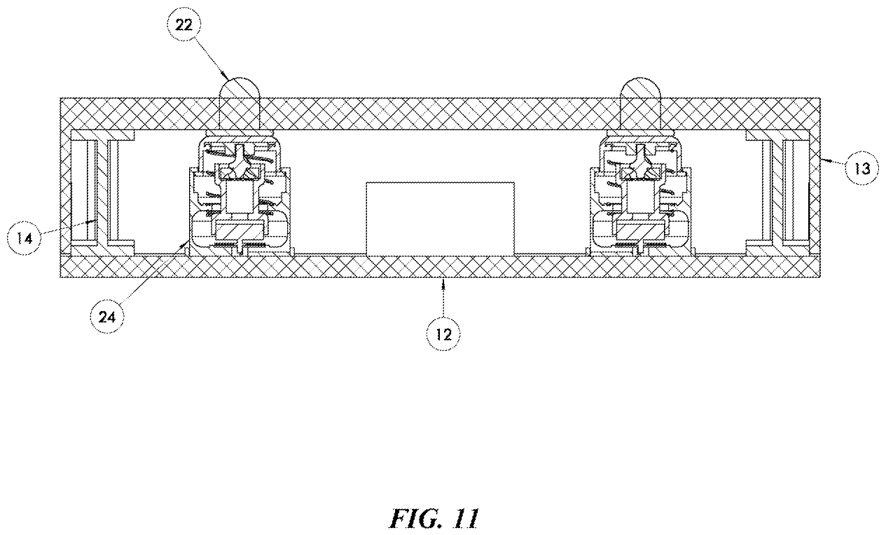

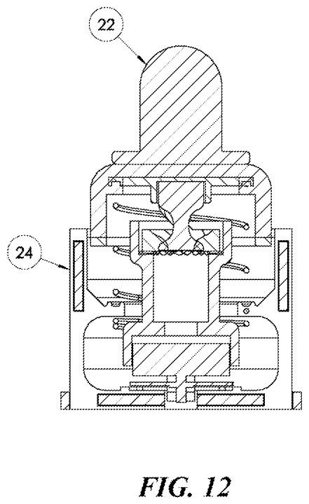

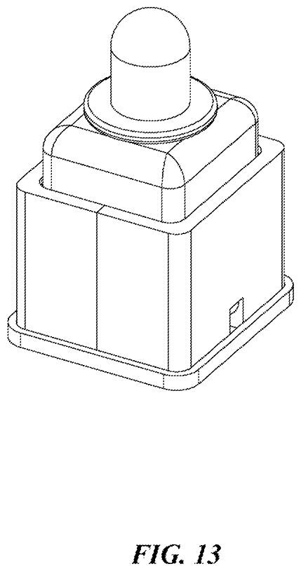

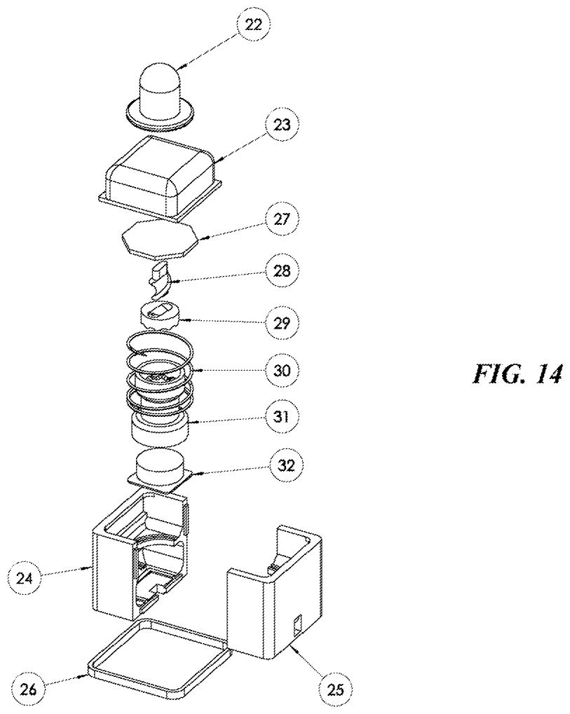

Another example of an energy harvesting system 200 is described with reference to FIGS. 8-14. FIG. 8 illustrates a top-down view of a roadway according to some embodiments of the energy harvesting system 200. FIG. 9 illustrates a top-down perspective view of the roadway of FIG. 8. FIG. 10 illustrates a top-down perspective view of the roadway of FIG. 8, with internal components made visible. FIG. 11 illustrates a cross-sectional side view of the roadway of FIG. 8, with internal components visible. FIG. 12 illustrates a close-up cross-sectional side view of a portion of the roadway of FIG. 8. FIG. 13 illustrates a close-up view of the portion of roadway of FIG. 12. FIG. 14 illustrates an exploded view of the portion of the roadway of FIG. 12. It will be understood that similarly numbered reference numerals in the figures refer to the same features throughout the disclosure.

The energy harvesting system 200 can comprise a baseplate 12, external surface 13, supports 14, slot plugs 15, wire inserts 16, tamper-resistant screws 17, pillars 21, actuators 22, generator housing top 23, generator housing side 24, generator housing side 25, generator housing bottom 26, screw interface 27, screw 28, nut 29, spring 30, disc 31, and generator 32.

The actuator 22 can be configured to come into contact with a movable unit and transform the contact force into displacement of the actuator. In some cases, the portion of the actuator 22 configured to contact the movable unit can form a portion of an upper external surface 13 of the energy harvesting system 200. In some instances, the external surface may include the top and sides of the encasement of the energy harvesting system. In some instances, the top may be permanently combined to the sides of the external surface of the energy harvesting system for ease of assembly. In other instances, parts of the external surface may also be temporarily combined by one or more fastening mechanism. Examples of fastening mechanisms may include, but are not limited to, latches, screws, staples, slips, pins, ties, adhesives (e.g., glue), a combination thereof, or any other types of fastening mechanisms. The fastening can be temporary, such as to allow for subsequent unfastening of the parts of the external surface without damage (e.g., permanent deformation, disfiguration, etc.) to either component. Beneficially, the energy harvesting device 200 may be easily accessed, such as for repair or cleaning, by detaching the parts of the external surface. In other instances, the fastening can be permanent, such as to allow for subsequent unfastening of the two connectors only by damaging at least one of the two components. Such configurations may increase sturdiness, robustness, and/or safety of the energy harvesting system, such as by preventing accidental detachment of the external surface from the energy harvesting system and exposing dangerous components to users and exposing the energy harvesting device to damage. The energy harvesting system 200 may be permanently or removably integrated in a surface of location. Removable integration may allow subsequent uninstalling (or disintegration) without damage to either component. Beneficially, the placement of the energy harvesting system 200 may be easily moved around, such as to optimize energy harvesting by placing the energy harvesting system 200 at the location that receives the most traffic at a particular time. Moreover, the energy harvesting system placement can adapt to changing landscape of an environment. The removability of the system may also increase modularity of the system and increase the flexibility of possible combinations with other modular system parts. In other instances, the installment can be permanent, such as to allow for subsequent uninstalling only by damaging the energy harvesting system and/or damaging the surface (e.g., excavating, breaking cement, etc.). As with above, such permanent configurations may increase sturdiness, robustness, and/or safety of the energy harvesting system, such as by preventing accidental displacement or detachment of the energy harvesting system from a surface location. Any portion or area of the upper external surface can be the actuator. The actuator may be sized such that the combination of the actuator and the upper external surface retains structural integrity and is capable of supporting the weight of the movable unit. The upper external surface may be planar, such as at a planarity of within about 1 centimeter (cm), 1 millimeter (mm), 1 micrometer (μm), or 1 nanometer (nm). Alternatively, the planarity can be within greater than 1 cm or less than 1 nm. For example, the exposed actuator may be planar with the upper external surface. The supports 14 support the weight of the movable unit that is traversing the external surface 13. The slot plugs 15 plug any unused openings in the external surface and base plate. Such openings in the external surface 13 and/or baseplate 12 are incorporated so that encasements can be connected in parallel, in series or in any other linear or nonlinear direction. Each base plate may include one or more connector pieces, so that multiple encasements can be connected to one another. For example, one base plate may have a female connector piece protruding out, while the next base plate can have a compatible male connector piece, and so on. In some instances, one base plate may have one or more connector pieces on each side surface. The connector pieces can have a dovetail shape or can have any other shape so that two connectors may interlock with one another. Slot plugs 15 are used when the openings for the connector pieces are not in use and it is necessary to prevent debris from entering the openings. The wire inserts 16 utilize openings within the external surface 13 so that electrical components can easily enter or exit the encasement by spooled through to the connected encasement or by being accessed outside of the encasement. For example, if one encasement is being utilized as a standalone system, then the wiring for the electrical components can enter and exit the encasement through the wire inserts 16, allowing the electrical components to be connected to nearby devices to be powered or electrical storage systems, such as batteries. Alternatively, or additionally, if multiple encasements are connected, the wire inserts 16 allow for the electrical components of each encasement to be connected to the electrical components of adjoining encasements. The wire inserts 16 may also prevent debris from entering the openings, thus preventing any damage to the electrical components within and in between encasements. The tamper-resistant screws 17 require a special tool to loosen the screws, preventing anyone with regular tools from breaking into the encasements and stealing or damaging the internal components.

Alternatively, or additionally, the portion of the actuator 22 configured to contact the movable unit can be a protrusion from the upper external surface. The protrusion can be a “node.” The protrusion can be shaped and dimensioned to achieve desired speed while avoiding excessive disturbance to the movable unit while the movable unit is traversing over the energy harvesting system. In some cases, a single upper external surface (e.g., a single module) may comprise a single node. In some cases, there can be more than one node per upper external surface (e.g., per module). In some cases, there can be as many as 1, 2, 3, 4, or more nodes protruding from the upper external surface. In some instances, the protrusions can have a height of at least about 0.5 inches, 1 inch, 1.5 inches, 2 inches or more. Alternatively, the protrusion may have a height less than 0.5 inches. Alternatively, or additionally, the distance between each protruding node may be determined in an effort to optimize the number of nodes that are depressed as a movable unit traverses the external surface. For example, the nodes may be placed in a pattern so that the wheels of a movable unit may depress 5 or more nodes at once. Alternatively, or additionally, there may be no nodes protruding from the upper external surface. In some cases, an actuator may comprise a single node exposed on the upper external surface. In some cases, an actuator may comprise a plurality of nodes exposed on the upper external surface. In some cases, the actuator may comprise a curved, convex portion configured to contact the movable unit. The curved, convex portion can be dimensioned to facilitate integration into a roadway, sidewalk, or path. For example, the curved, convex portion of the actuator can comprise a semicircular cross-section. In some cases, the curved, convex portion of the actuator can comprise a semi-elliptical, arcuate, and/or parabolic cross-section. In some cases, the cross-section of the portion of the actuator which contacts the movable unit can comprise a shape other than a curved, convex shape, such as a polygonal shape.

In some cases, the actuator 22 can be configured to increase the amount of force inputted into the system, for example, enabling an increase in the amount of energy outputted from the system. The actuator can be shaped and/or dimensioned (e.g., height, width, length, and/or height of depression) to avoid excessive disturbance and/or unreasonable discomfort for humans, animals, or items that may be inside the movable unit as the movable unit traverses over the speed bump, roadway, sidewalk, or path.

In some embodiments, the linear to rotational mechanism may capture forces coming from a plurality of directions, for example, a vertical direction, a horizontal direction, a normal direction (e.g., normal to the surface in which the energy harvesting device is integrated), or any other angled forces. Such forces may be converted into rotational motion via the linear to rotational mechanism.

FIG. 14 illustrates an example of a generator module. The generator module may comprise a generator housing, comprising a generator housing top 23, generator housing side 24, generator housing side 25, and generator housing bottom 26. The housing may contain therein a screw interface 27, screw 28, nut 29, springs 30, disc 31, and generator 32. When the actuator 22 is displaced during contact with the movable unit, movement of the actuator can be transferred to the generator housing top 23, effectively transferring the force to the screw 28. The screw can be in contact with a lower surface of the generator housing top, such as via an attachment piece. The attachment piece can be the screw interface 27. Movement of the actuator can displace the screw 28. The generator housing top and/or the actuator can be coupled to the springs 30 such that the actuator is maintained in an undepressed state when no pressure is exerted upon the actuator. For example, after the movable unit has moved over and past the energy harvesting system 200, the springs can push the actuator, and attached screw, outwards and back to their initial undepressed position.

An energy harvesting system (e.g., 200) can comprise one or more generators and their respective housings, as seen in FIG. 10, including 1, 2, 3, 4, 5, 6, 7, 8, 9, 10 generators or more. In some cases, the system can comprise more than one generator for each actuator. Alternatively, or additionally, more than one actuator can be connected to one generator and its housing.

The energy harvesting system 200 can comprise a nut 29 configured to be in contact with the screw 28, for example as shown in FIG. 12 and in further detail in FIG. 14. The nut 29 can be configured to engage with the screw 28 such that depression of the actuator 22 translates to displacement of the screw, which results in rotational movement of the nut. The nut 29 may rotate about the axis of the screw 28 as the screw 28 is translated along the screw axis. Whole a helical screw relationship is disclosed herein, other types of screw may be employed. The nut can then be configured to engage with the disc 31 such that rotation of the nut also rotates the disc, such as via the engagement of complementary features (e.g., key-like features), such that rotation of the nut 29 translates to rotation of the disc 31. In some instances, the disc 31 may rotate coaxially with the screw axis. Upon release of the depression, the nut 29 may disengage with the disc 31 (e.g., separation of the complementary features), such that a rotation of the nut 29 does not cause a corresponding rotation of the disc 31. That is, the disc 31 may rotate with the nut 29 only while a certain amount of depression of the screw 28 is maintained. Rotation of the disc 31 translates to rotation of the generator 32, thus generating electrical energy. The screw can be a lead screw comprising a male threaded rod. The nut can have a coordinating female threaded cylinder. Alternatively, the screw can be a female threaded cylinder and the nut can be the coordinating male threaded rod. The screw can have a thread size that maximizes rotational output for linear input. The screw can provide multiple advantages as a linear to rotational system, including but not limited to, large load carrying capability, compact design, ease of manufacturing, precision, accuracy, smoothness, quietness, and generally low maintenance. The screw/nut pair can also be replaced by one or more of a ball screw, roller screw, rack & pinion, worm drive, or other linear to rotational linkage or subsystem. The nut can be attached to a planetary gear system, or epicyclic gear train, which can comprise one or more outer gears, or “planets,” revolving about a central gear. In some instances, the attached gears increase or decrease the gear ratio or assist in translation of motion. The gear ratio of the planetary gear system can either increase or decrease the rotational input, thereby either producing a higher or lower rotational output, respectively.

Upon release of the movable unit and thus release of the depression, the spring 30 is able to automatically return to its uncompressed state, thus returning the generator housing top 23 and the actuator 22 to their original position. The stiffness of the spring 30 is able to be adjusted, such that compression and/or expansion may be restricted to a certain range. Beneficially, the spring stiffness may directly affect the user or movable unit's perception of the depression as the user or movable unit travels across the surface. Such spring stiffness can be set up to limit the negative reaction (or any reaction) the user may experience from the actuator depressing.

The rotational output of the linear to rotational mechanisms described with respect to system 200 may translate into movement of a mechanical storage device. For example, the mechanical energy storage component can comprise a torsional spring configured to wind in a first direction to store the rotational motion output and unwind in a second direction opposite the first direction to release the mechanical energy. In some instances, the mechanical energy storage component can comprise a flywheel mechanically coupled to the generator. In some embodiments, the system further comprises a one-way clutch disposed between the flywheel and the generator, or a ratchet and pawl system. Once the flywheel 9 is initiated, the flywheel 9 may continue to rotate steadily for some time, in some instances, even after all other parts of the energy harvesting device may have stopped their respective movements. The one-way clutch may, for example, allow the flywheel 9 to rotate with less frictional interference after the other parts have stopped movement. The flywheel 9 is designed such that the weights can be adjusted depending on the duration of rotation desired.

For example, referring to FIG. 1 and FIG. 5, to provide a mechanical energy storage mechanism, the main shaft 4 can be coupled to the gearbox 8, the flywheel 9, and the generator 10, wherein the flywheel is the mechanical storage device. The gear box, flywheel, and generator can be coupled to the main shaft via shaft coupler 11. Rotation of the main shaft then can result in rotation of the gearbox, flywheel, and generator. Referring to FIG. 14, the mechanical energy storage mechanism, described with respect to system 100, can be connected to the generator 32. For example, the disc 31 can be connected to a gearbox (e.g., gearbox 8), flywheel (e.g., flywheel 9), and the generator 10 via a shaft (e.g., main shaft 4). The gearbox can comprise a step-up or step-down gear box system. For example, the gearbox can be configured to reduce torque applied upon the main shaft 4 and increase the rate of rotation of the main shaft (e.g., rotations per minute). The gear box system may be coupled to an input spindle (e.g., the main shaft 4) and an output spindle (e.g., a shaft for coupling to the flywheel and/or generator). The gear box system may be configured (e.g., calibrated, dimensioned) to achieve a predetermined output spindle rotation speed (e.g., a predetermined number of revolutions per minute). For example, the main shaft may be connected to the input spindle, and the output spindle may drive the flywheel. The gearing may be configured to spin the output spindle at an appropriate speed for the flywheel, or any other spinning or rotating device or system which may be coupled to the output spindle.

The gearbox can be configured to convert high torque and low rpm to lower torque and higher rpm. The gearbox ratio can be selected based on the applied torque and the desired rate of rotation of the main shaft. As shown in FIG. 1, the gearbox can be positioned between the main shaft and the flywheel. In some cases, the gearbox can be omitted.

The flywheel can be configured to store mechanical energy. The flywheel can store mechanical energy generated as a result of rotational movement of the shaft (e.g., rotated from rotation of the disc 31). The moment of inertia of the flywheel can be selected to provide desired energy storage. In some cases, the amount of energy stored in the flywheel can be increased by increasing the rotational speed or by increasing the moment of inertia. For example, weights can be added to the flywheel to increase the moment of inertia. Increasing the amount of energy stored by the flywheel and increasing the duration in which energy is stored can increase the total energy generated from the energy harvesting system.

In some cases, other types of mechanical energy storage can be used, including for example, a torsion spring. The flywheel can be used alone or in combination with another type of mechanical energy storage. For example, an energy harvesting system can comprise one or more of a flywheel and a torsion spring. In some cases, a torsion spring can be used instead of a flywheel.

The generator 10 and the generator 32 can be configured to generate electrical energy from stored mechanical energy. In some cases, the generator can comprise an induction generator. In some cases, the generator can comprise an off-the-shelf motor. In some cases, a customized induction generator can be designed to provide desired amount of electrical energy output. A customizable generator can provide for example, desired damping constant and/or power output. In some cases, the generator can comprise a two-part generator comprising a stator and a rotor, wherein either a stator or rotor is configured to rotate relative to the other upon release of the mechanical energy.

The energy harvesting system 100 and the energy harvesting system 200 can comprise electrical circuitry (not shown) to deliver electricity generated by the energy harvesting system to an external circuit. The electrical circuitry can deliver electricity to an external load. The electrical circuitry can deliver electricity to one or more electrical storage systems (e.g., batteries). Electrical circuitry is described further below.

In some cases, one or more components of the energy harvesting system 100 can be housed within a metal frame (not shown). In some cases, the metal frame may house all components of the system. In some cases, only some of the components are housed within the metal frame. For example, the gearbox 8, flywheel 9, and generator 10 may not be contained within the metal frame. The metal frame can be configured to facilitate rapid deployment of the system, for example facilitating implantation of the system into the ground, and/or provide ease of installation. For example, the metal frame can be configured to reduce the number of steps used to properly install the system in the ground such that the actuator 1 is properly positioned and protruding from the ground. The frame may also be configured so that most of the fabrication and assembly is done prior to installing the system on-site to achieve rapid installation. Alternatively, the energy harvesting system can be housed within a non-metal frame or hybrid (e.g., metal and non-metal) frame.

An energy harvesting system, or a speed bump comprising the energy harvesting system, can have a modular configuration can facilitate incorporation of the system into one or more of roadways, floor panels, highways, sidewalks, and/or general walking/driving surfaces (e.g., both outdoor and indoor walkways and/or driving surfaces).

In some cases, one or more components of the energy harvesting system 200 can be housed within an encasement. As shown in FIG. 9, the encasement can consist of an external surface 13 and a base plate 12. The external surface can consist of a top plate and side plates, which may be permanently or temporarily connected together. Connectors may include but are not limited to screws, fasteners, or brackets. The encasement can be configured to facilitate rapid deployment of the system and ease of connecting multiple encasements to one another. Each base plate may include one or more connector pieces, so that multiple encasements can be connected to one another. For example, one base plate may have a female connector piece protruding out, while the next base plate can have a compatible male connector piece, and so on. In some instances, one base plate may have one or more connector pieces on each side surface. The connector pieces can have a dovetail shape or can have any other shape so that two connectors may interlock with one another. The interlocking features may provide many benefits including but not limited to ease of installation and theft protection. The encasement can also be configured to facilitate implantation of the system into the ground, and/or provide ease of installation. For example, the encasement can be configured to reduce the number of steps used to properly install the system in the ground such that the actuator 22 is properly positioned and protruding from the ground.

An energy harvesting system, or an encasement comprising the energy harvesting system, can have a modular configuration to facilitate incorporation of the system into one or more of roadways, floor panels, highways, sidewalks, and/or general walking/driving surfaces (e.g., both outdoor and indoor walkways and/or driving surfaces). The system can be expanded by connecting multiple encasements in series to increase the overall length of the system. Alternatively or in addition, the system may also be expanded by connecting multiple encasements in parallel to increase the overall width of the system. Alternatively, the system can be expanded by connecting multiple encasements in any nonlinear direction. The system may comprise an array (e.g., having one or more columns and one or more even or uneven rows) of multiple encasements. While rectangular encasements (e.g., cuboids) are illustrated, it will be appreciated that the encasements can have any shape, form, and dimensions. In some instances, the system may comprise at least 1, 2, 3, 4, 5, 6, 7, 8, 9, 10, 20, 30, 40, 50, 60, 70, 80, 90, 100, 200, 500 or more encasements connected to each other. The encasements may vary in other optical characteristics, such as texture and/or color. The encasements may vary in material (e.g., plastic, metal, cement, rubber, etc.). The encasement may be designed to be adaptable to multiple scenarios and situations and can be both safe and durable in such scenarios and situations. For example, the encasement and corresponding external surface can be designed specifically for outdoor environments, such as ground material for walkways, sidewalks, crossroads, roads, lawns, parks, and other outdoor applications. The external surface material may be selected for the appropriate environment (e.g., cement or gravel for outdoor environments, etc.). For example, the external surface may contain a material that creates a rough texture that creates grip and prevents slippage for pedestrians and vehicles alike.

The electrical circuitry may process power output from the energy harvesting system 100. The electrical circuitry can comprise impedance matching, for example to provide input resistance of an electrical load of its corresponding signal source to improve the power transfer. In some instances, the electrical circuitry may comprise (and/or be electrically connected to) suitable circuits to provide AC current and/or DC current. The electrical circuitry may be capable of converting AC to DC and vice versa. In some instances, an electrical circuitry may amalgamate multiple sources of power output, such as from multiple modular energy harvesting systems (e.g., energy harvesting system 100), into a larger more effective amount of power output. Distinct power outputs from other combinations of energy harvesting devices (e.g., intra-unit, inter-unit) may be amalgamated.

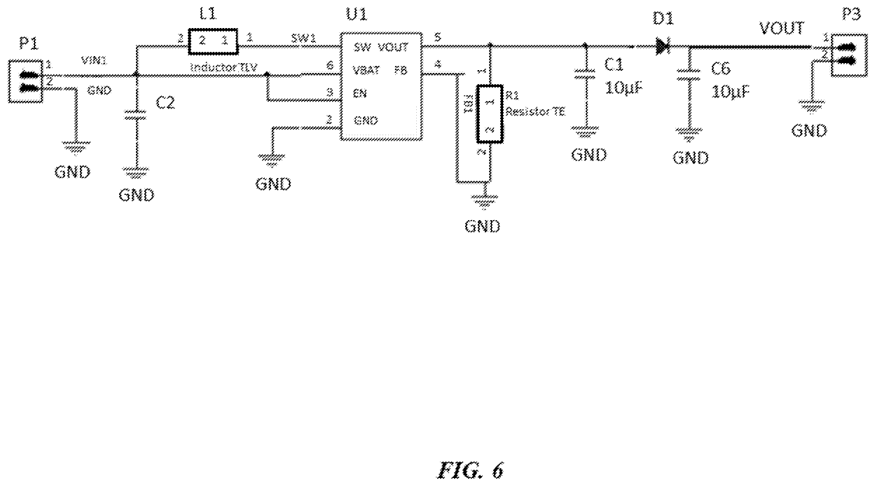

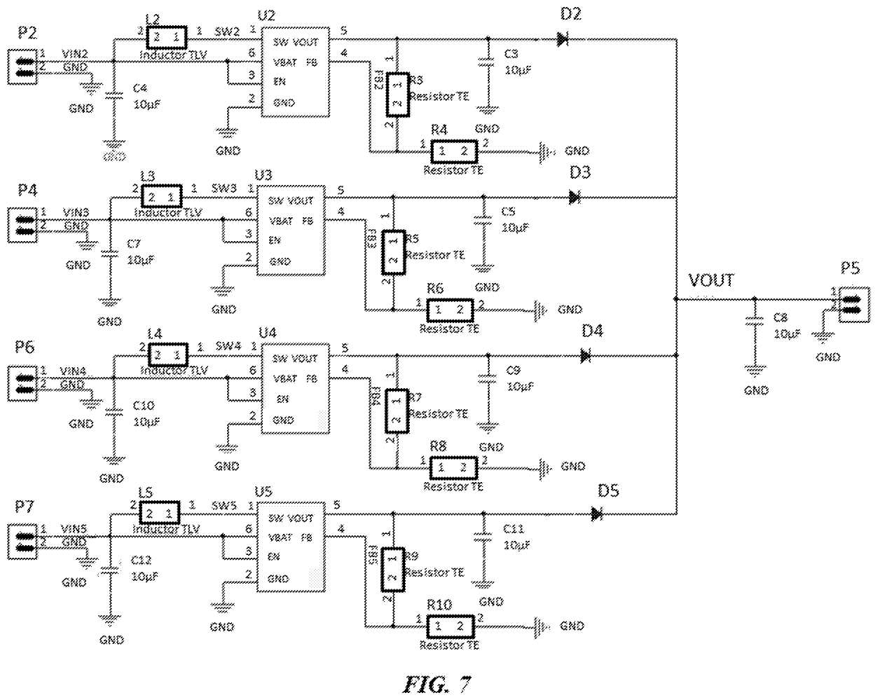

FIGS. 6 and 7 show exemplary circuits that can be used for power output processing, such as amalgamation.

FIG. 6 shows an exemplary circuit for a boost converter (e.g., DC-to-DC power converter), in accordance with embodiments of the invention. For example, in FIG. 6, the power output (e.g., voltage) of an energy generating device P1, such as the energy harvesting system 100 described herein or other type of energy generating device, is boosted to produce the stepped up power output P3. The boost converter may comprise one or more of each of: inductors, transistors, and other electrically resistive elements. Beneficially, the boost converter may compensate for an energy harvesting system that produces outputs with insufficiently low potentials. In other embodiments, an energy harvesting system may be connected to a buck converter, such as to compensate for the energy harvesting system that produces outputs with high potential and low current. The buck converter may comprise one or more of each of: inductors, transistors, and electrically resistive elements.

In some embodiments, a plurality of energy generating devices, such as the energy harvesting system 100 described herein, may be connected through a circuit designed to combine their outputs into one coherent power source. Such power amalgamating circuits can have multiple inputs, each connected to an energy generating device. The energy generating device may be of the same or different type. Any combination of two of more energy generating devices may be electrically amalgamated. Electric power may then be delivered from multiple energy harvesting systems to a single power amalgamating circuit. The power amalgamating circuit can have a single output which delivers the power harvested from the multiple generators to external electronics. Examples of external electronics include, but are not limited to LEDs, mobile devices (e.g. laptops, cell phones, etc.), refrigerators, and HVAC units. External electronics may also receive power from other sources including traditional grid-connected sources. External electronics may also receive power from a combination of sources including traditional grid-connected sources and energy harvesting devices. In some instances, the energy harvested via the energy harvesting systems integrated in a speed bump or road can be used to power other devices integrated in the road and/or speed bump, such as street lights, street lamps, or other applications. Alternatively, or additionally, generated electricity can be delivered to power, for example light sources, security systems, WIFI hotspots, data acquisition devices, nearby homes, schools, hospitals, governmental buildings, community centers, other buildings requiring power, microcontrollers, converters, sensors, energy monitoring systems, microprocessors, including accessories like data storage, network equipment, and any other electrical load. The devices receiving power may be 1 meter, 2 meters, 3 meters, or less away from the energy harvesting devices. The devices receiving power may also be 10 meters, 20 meters, 30 meters, or more away from the energy harvesting devices. The energy harvesting system can transmit the power from the location of the energy harvesting device up until the device receiving power, regardless of the distance between them.

FIG. 7 shows an exemplary amalgamation circuit, in accordance with embodiments of the invention. The respective power outputs of a plurality of energy generating devices P2, P4, P6, and P7 are amalgamated to produce a single power output P5. Each power output of the plurality of energy generating devices P2, P4, P6, and P7 may be boosted (e.g., by parallel boost circuits for each energy generating device) to substantially equal or similar levels to generate the enhanced power output P5. The enhanced power output, for example, may be applied across a load. While FIGS. 6 and 7 show certain circuit configurations for boost converters and/or amalgamation, as will be appreciated, the configurations are not limited as such. For example, the power outputs of the plurality of energy generating devices may be boosted by a single boost circuit instead of a plurality of parallel boost circuits.

Beneficially, the amalgamation system of the present disclosure may aggregate power generated from a plurality of individual modular energy harvesting systems to produce a single larger power output, which may be more practical for use in various electrical needs compared to smaller, and distributed, power outputs. For example, small pockets of power may not be usable or applicable to devices requiring at least a certain threshold amount of power. Modularity can provide other benefits, such as increasing efficiency of energy harvesting. For example, a single object or human traveling across a surface may only exert force at one location for each instance of travel, and a single energy harvesting system may not be able to capture the full extent of kinetic forces (e.g., motion force) exerted at different locations. Beneficially, individual energy harvesting systems can be integrated or otherwise installed at a plurality of individual and distinct locations (e.g., in surfaces intended for travel or other traffic) to receive concentrated forces at different points in time and generate power from the different locations. The individually generated power can be amalgamated to produce a single larger power output.

The electrical energy generated by the energy generating system and/or amalgamated by one or more amalgamation circuits can be stored in an electrical power storage component and/or used to power other systems, components, and devices. The electrical power storage component may comprise one or more disposable batteries, rechargeable batteries (e.g., lithium ion batteries), other electrochemical storage systems, capacitors, supercapacitors, fuel cells, alternatively energy storage systems, and/or other suitable devices for storing electrical energy. The electrical power storage component may be a component of the energy harvesting system 100 and/or 200. Alternatively, the electrical power storage component may be a separate component external to the energy harvesting system 100 and/or 200. In some cases, the electrical power storage component may be disposed within a housing (e.g., metal frame) of the energy harvesting system. The electrical power storage component may be electrically coupled to one or more generators of the energy harvesting system. The energy harvesting system and the electrical power storage component may be connected via a printed circuit board, cables, wires or other suitable electrical connectors. The printed circuit board may regulate the storage of electricity in one or more power storage components. The printed circuit board may be disposed in the housing of the energy harvesting system.

The electrical energy generated by the energy harvesting system 100 and/or 200 may be used to power or charge a device that requires electricity for operation. The electrical energy may be used to power one or more external devices, for example, devices carried by a person such as a smart phone, computer, a radio, a flash light, and various other devices that may or may not be within proximity to the energy harvesting system 100 and/or 200. The device can be a personal device. The device may not be a personal device (e.g., utilities, facilities, etc.). The device can be a mobile device. The device can be a remote device. The device can be a utility device (e.g., street lamp, street light, etc.).

In some embodiments, the power storage component can comprise one or more capacitors having a high capacitance, a high energy density, and/or a high power density. Such high-capacity capacitors are commonly known as ultracapacitors (or supercapacitors) and can store relatively large amounts of electrical energy. The electrical power storage component may utilize different energy storage technologies, e.g., an ultracapacitor or a Lithium Vanadium Pentoxide battery. The electric storage component may comprise electronic components, including, for example, capacitors, diodes, resistors, inductors, transistors, regulators, controllers, batteries, and any other suitable electronic device. In some embodiments, the additional electronic components can assist in storing and discharging electrical energy and in directing the electrical energy to suitable systems.

One or more features and/or parameters of the energy harvesting system described herein can be modified to fit into a variety of different applications (e.g., different road surfaces). The energy harvesting system can be paired with one or more similar mechanisms, such as mechanisms harnessing energy from rotational motion, triboelectric energy, solar, piezoelectric energy, and/or impact driven motions, to create a system capable of generating greater levels of power so as to power large scale electrical systems, which can be particularly useful in areas without well-developed electrical grid systems. These other energy harvesting mechanisms can for example be incorporated into one or more speed deterring systems described herein, and/or form a separate standalone system paired together via electrical amalgamation and/or mechanical amalgamation with the speed deterring systems.

In some cases, the energy harvesting systems described herein can be used in combination with any number of available electrical amalgamation systems so as to improve the energy generation capabilities of the speed deterring system using energy from multiple different energy harvesting systems. In some cases, varying levels of power can be produced. By amalgamating various amounts of power from various energy harvesting systems, greater amount of power can be outputted together, enabling powering of large scale systems, such as power for industrial use.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A modular energy harvesting system, comprising:
a first modular housing comprising:
an actuator comprising a translationally displaceable surface, the translationally displaceable surface being configured to transition from a first position to a second position upon contact by a movable unit;
a linear to rotational conversion component for converting linear motion input from the actuator into a rotational motion output, wherein the linear to rotational conversion component is mechanically coupled to the actuator to receive the linear motion input from the transition of the translationally displaceable surface from the first position to the second position;
a mechanical energy storage component mechanically coupled to the linear to rotational conversion component to store at least part of the mechanical energy derived from the rotational motion output;
a generator coupled to the mechanical energy storage component, wherein the generator is configured to generate electrical energy from the mechanical energy stored by the mechanical energy storage component; and
a first modular connector disposed on a first surface of the first modular housing and a second modular connector disposed on a second surface of the first modular housing.

2. The system of claim 1, further comprising a second modular housing comprising a third modular connector engaging the first modular connector.

3. The system of claim 2, further comprising a third modular housing comprising a fourth modular connector engaging the second modular connector.

4. The system of claim 1, further comprising a gearbox coupled to the linear to rotational conversion component and the mechanical energy storage component.

5. The system of claim 1, wherein the linear to rotational conversion component comprises a rack and pinion mechanism.

6. The system of claim 1, wherein the linear to rotational conversion component comprises a screw transmission.

7. The system of claim 1, wherein the mechanical energy storage component is a flywheel.

8. The system of claim 1, wherein the first modular housing is disposed beneath a contact surface traversed by the movable unit.

9. The system of claim 8, wherein the contact surface is one or more of a speedbump and roadway.

10. The system of claim 1, wherein the translationally displaceable surface of the actuator protrudes from an external surface of the first modular housing.

11. The system of claim 1, further comprising a release mechanism mechanically coupled to the mechanical energy storage component, wherein the mechanical energy is released from the mechanical energy storage component to the generator upon activation of the release mechanism.

12. The system of claim 11, wherein the release mechanism comprises one or more of a latch and valve configured to activate when the stored mechanical energy reaches a predetermined threshold.

13. The system of claim 1, further comprising an electrical energy storage component electrically coupled to the generator.

14. The system of claim 1, wherein the generator is a two-part generator comprising a stator and a rotor, wherein either a stator or rotor is configured to rotate relative to the other upon release of the mechanical energy storage component.

15. The system of claim 1, wherein the generator is an induction generator configured to rotate upon release of the mechanical energy of the mechanical energy storage component.

16. An energy harvesting system, comprising:
an actuator comprising a translationally displaceable surface, the translationally displaceable surface being configured to transition from a first position to a second position upon contact by a movable unit;
a vertical rack in contact with the actuator, and configured to be translationally displaced in response to translational displacement of the actuator;
a pinion configured to engage with the vertical rack and to rotate in response to translational displacement of the vertical rack;
a main shaft coupled to the pinion and configured to rotate with rotation of the pinion; and
a flywheel and a generator coupled to the main shaft, wherein rotation of the main shaft generates mechanical energy stored by the flywheel, and wherein the generator is configured to generate electrical energy from the mechanical energy stored by the flywheel.

17. The system of claim 16, further comprising a gearbox coupled to the main shaft.

18. The system of claim 16, further comprising a frame housing the actuator, the vertical rack, the pinion, the main shaft, and the flywheel.

19. The system of claim 16, wherein the frame is disposed beneath a contact surface traversed by the movable unit.

20. The system of claim 19, wherein the contact surface is one or more of a speedbump and roadway.

21. A method for harvesting energy, comprising:
(a) providing at each of a plurality of locations on a surface, including a first location and a second location, a modular housing, comprising: (i) an actuator configured to transition from a first position to a second position upon contact by a movable unit exerting a force on the surface; (ii) a linear to rotational conversion component for converting linear motion input from the actuator into a rotational motion output, wherein the linear to rotational conversion component is mechanically coupled to the actuator; (iii) a mechanical energy storage component mechanically coupled to the linear to rotational conversion component; (iv) a generator coupled to the mechanical energy storage component; and (v) electric circuitry electrically coupled to the generator;
(b) at the first location and the second location, receiving a linear motion input from the movable unit exerting the force on the surface;
(c) converting each linear motion input into respective rotational motion outputs via the respective linear to rotational conversion components in the first and second locations;
(d) storing each of the respective rotational motion outputs as mechanical energy in the respective mechanical energy storage components in the first and second locations;
(e) releasing the mechanical energy to the respective generators in the first and second locations, thereby generating respective power outputs at the first and second locations on the surface; and
(f) amalgamating the respective power outputs from the first and second locations, via the respective electric circuitry at the first and second locations, to produce an amalgamated power output and delivering the power output for storage in a power storage component or for powering one or more electronic devices.
